(19) United States
(12) Patent Application Publication
(10) Pub. No.: US 2024/0403433 A1
(43) Pub. Date: Dec. 5, 2024

(54) METHOD FOR SECURE INSTALLATION OF A SOFTWARE UPDATE

(71) Applicant: STMicroelectronics International N.V., Geneva (CH)

(72) Inventors: Michel JAOUEN, Yvre L'Eveque (FR); Frederic RUELLE, Marigne-Laille (FR)

(73) Assignee: STMicroelectronics International N.V., Geneva (CH)

(21) Appl. No.: 18/665,124

(22) Filed: May 15, 2024

(30) Foreign Application Priority Data
May 30, 2023 (FR) 2305373

(51) Int. Cl. G06F 21/57; G06F 8/61; G06F 8/65

(52) U.S. Cl. CPC G06F 21/572; G06F 8/61; G06F 8/65; G06F 2221/033

(57) ABSTRACT

An electronic device receives data including an application update module for an application program, the application update including a first part, the first part including first update information and an indication value. A processor of the electronic device then compares the first update information with reference information associated with the indication value and stored in a memory of the electronic device. The processor then installs a second part of the application update module when the first update information corresponds to the reference information, thereby producing an updated application program.

### PRIORITY CLAIM

This application claims the priority benefit of French Application for U.S. Pat. No. 2,305,373, filed on May 30, 2023, the content of which is hereby incorporated by reference in its entirety to the maximum extent allowable by law.

### TECHNICAL FIELD

The present disclosure relates generally to methods of installing application program updates on devices connected to networks, such as Internet of Things (IoT) devices connected to the Internet.

### BACKGROUND

Devices connected to a network, such as IoT devices connected to the Internet, are configured to receive software update modules. Software update modules can, for example, be used to update application programs in a memory of device.

However, during the reception and installation of software update modules, electronic devices are not in a secure environment. Indeed, the electronic devices are, for example, being used and are in the hands of the end user. Furthermore, the device manufacturer has, for example, no control over the programming of the software update modules.

It is generally desirable that, following the installation, the whole system defining the device remains coherent. It can also be desirable to make sure the device operates correctly after the update while ensuring that the update does not grant extra privileges to the updated application.

### SUMMARY

One embodiment provides a method including: receiving, by an electronic device, data including a software update module for an application program of the device, the software update module having a first part with first update information and an indication value; comparing, by a processor of the device, the first update information with reference information stored in a memory of the device in association with the indication value; and installing, by the processor, a second part of the application update module when the first update information corresponds to the reference information.

According to one embodiment, the indication value is an identifier of the application.

According to one embodiment, the indication value is a value identifying a category of application programs.

According to one embodiment, the method further comprises, before the comparison of the first update information with the reference information, verifying the authenticity and/or integrity of the software update module.

According to one embodiment, the first information is unencrypted data.

According to one embodiment, the second part of the software update module includes encrypted data, and the method includes, before installation, decrypting the encrypted data by a cryptographic circuit of the device.

According to one embodiment, the first information indicates a set of resources of the device used during the execution of the updated application.

According to one embodiment, the resources are peripheral circuits of the electronic device, and/or buses of the electronic device, and/or software code stored in a non-volatile memory of the electronic device.

According to one embodiment, the reference information associated with the indication value indicates a set of authorized resources for the indication value and the first update information corresponds to the reference information when the resources in the set of resources belong to the authorized set of resources.

According to one embodiment, the method also includes, after the installation of the software update module, performing a recording phase in which the software update module is recorded. The recording phase includes: sending an indication of a set of resources required during the execution of the updated application to the processor; comparing the set of resources required with the set of resources indicated in a first part of the software module by the processor; and when the sets of resources correspond, storing the indication value in association with the application.

According to one embodiment, the method also includes, during the execution of the updated application by the processor, sending a request for the use of a resource of an electronic device; and verifying, based on the indication value stored in association with the application, whether the use of the device is authorized.

According to one embodiment, the above method also includes, if the first and second information do not correspond, deleting the software update module.

According to one embodiment, the above method also includes, after installation of the software update module, and when the updated application is active, deactivating the resources not included in the set of resources authorized for the indication value.

According to one embodiment, the authorized sets of resources are stored, in association with the indication value, in a memory of a secure circuit.

One embodiment provides an electronic device including: an interface configured to receive data including a software update module for an application program stored in a memory of the device, the software update module having a first part comprising first information and an indication value; and a processor configured to compare the first information with reference information stored in a memory of the device in association with the indication value, the processor being further configured to command, when the first information corresponds to the reference information, the installation of the software update module.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 is a block diagram illustrating an example of an electronic device according to an embodiment of the present description;

FIG. 2 illustrates the structure of the header of a software update module according to an embodiment of the present description;

FIG. 3 is a flow diagram illustrating the steps in a method for installing a software update module, according to an embodiment of the present description;

FIG. 4 is a block diagram illustrating the installation of a software update module according to an embodiment of the present description; and

FIG. 5 is a flow diagram illustrating the steps in the recording of a software update module according to an embodiment of the present description.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, the methods of verifying the authenticity and/or the integrity of the software module received are not described in detail and are known to those skilled in the art.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

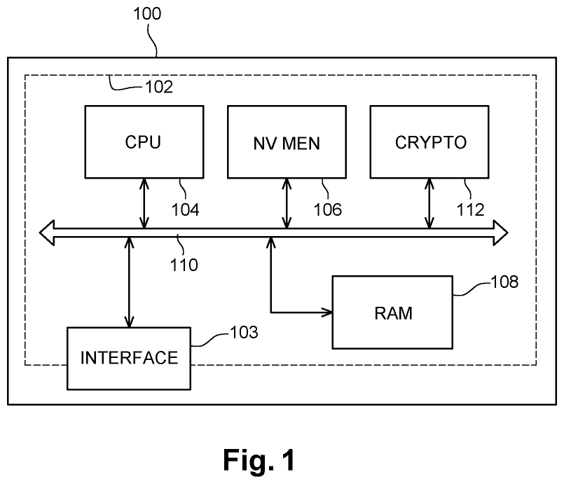

FIG. 1 is a block diagram illustrating an example of an electronic device according to an embodiment of the present description. In particular, the electronic device 100 comprises a circuit 102.

As an example, the device 100 is a smartphone, a connected object such as a smartwatch, an element of a home automation system, etc. In general, the device 100 is an Internet of Things device connected to a network. The integrated circuit 102 further comprises, for example, an interface 103 (INTERFACE). The interface 103 is, for example, configured to receive data that flows through the network to which the device 100 is connected.

The circuit 102 comprises for example a processor 104 (CPU). The circuit 102 furthermore comprises a non-volatile memory 106 (NV MEM) and/or a volatile memory 108 (RAM). As an example, the non-volatile memory 106 is a Flash memory. As an example, the volatile memory 108 is a random access memory. The memories 106 and 108 are for example coupled to the processor 104 through a bus 110. As an example, the non-volatile memory 106 comprises memory locations in which application programs are stored. When they are executed, the application programs use for example the resources of the circuit 102 such as peripheral circuits (not illustrated), such as a type I²C bus (Inter-Integrated Circuit), or UART (Universal Asynchronous Receiver-Transmitter) interface. As an example, the device 100 comprises a circuit implementing a camera, a circuit implementing a Global Positioning System (GPS), etc., and some application programs use the camera and/or the GPS and/or other types of peripheral circuits. When they are executed, the application programs further use software code for example stored in the non-volatile memory 106.

The circuit 102 further comprises for example a cryptographic circuit 112 (CRYPTO) coupled to the bus 110. As an example, the cryptographic circuit 112 is configured to encrypt and/or decrypt data, received for example through the bus 110, according to a symmetric encryption algorithm or according to an asymmetric encryption algorithm.

According to one embodiment, the interface 103 is configured to receive software update modules, for example firmware modules, sent through the network to which the device 100 is connected. As an example, a software module is sent wirelessly, for example by radio frequency (RF) signal. As an example, a software update module is used to update code for one of the applications stored in the non-volatile memory 106. However, in most cases, the software update modules sent to the device 100 are not programmed by the same entity as that which programmed the application code and/or that designed the circuit 102.

As an example, the software update modules take the form of a Binary Logical Object (BLOB). In particular, the software update modules comprise a header in which several pieces of information are indicated. The software update modules further comprise the update code. As an example, the update code is an encrypted code and the cryptographic circuit 112 is configured to decrypt it.

As an example, the information comprised in the header is not encrypted. In another example, the information comprised in the header is encrypted and the cryptographic circuit 112 is configured decrypt it.

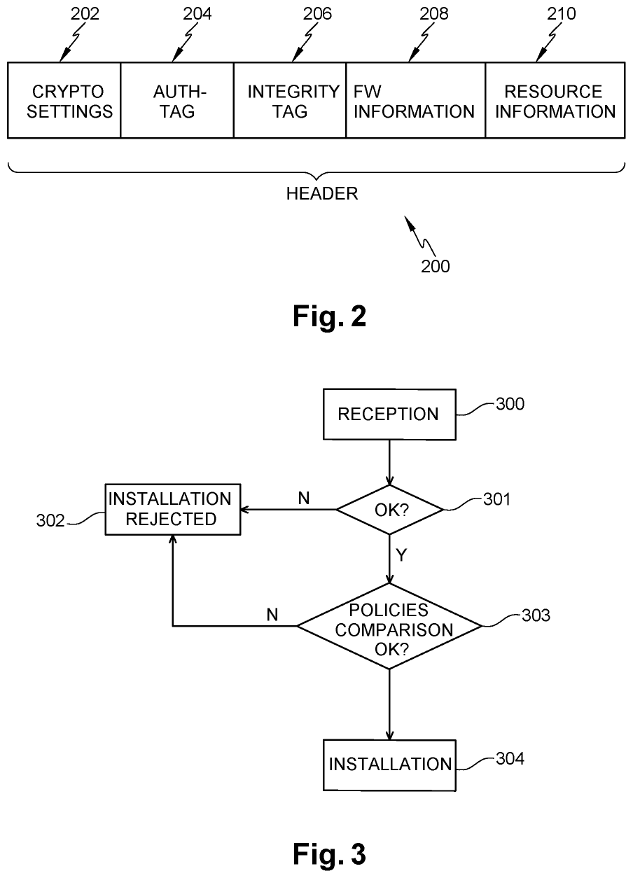

FIG. 2 illustrates the structure of a header 200 (HEADER) of a software update module according to an embodiment of the present description.

As an example, the header 200 comprises the information 202 (CRYPTO SETTINGS), 204 (AUTH.TAG), 206 (INTEGRITY TAG) and 208 (FW INFORMATION). The information 202 is for example information related to the encryption settings of the update code. The information 204 comprises for example an authentication value. As an example, the authentication value is generated during the programming of the software update module. As an example, the authentication value is a digital signature, for example associated with the application code concerned by the update. The information 206 comprises for example an integrity value. As an example, the integrity value is generated during the programming of the software update module. As an example, the integrity value is a hash value. As an example, the hash value is obtained by applying an SHA-256 algorithm to the update code and to the binary logic object defining the update module. A signature associated with the hash value, together with an asymmetric key are added after the hash value. When the update module is received, the integrity of the module is verified by calculating a hash value from the code and the received binary logic object, and comparing it with the hash value comprised in the information 206. The module is for example authenticated after a signature check based on a public key. The public key is, for example, previously stored in a non-volatile memory of the device 100. As an example, the public key is stored in the device 100 during manufacture of the latter. As an example, the public key is associated with a private key that has been used in calculating the signature of the hash value. The information 208 comprises for example information such as the application program concerned by the update and/or the update version. As an example, on reception of the update module, the version is compared with the software version already installed on the device 100. As an example, if the update module version is an older version than the software installed, the software is not updated so as, for example, to avoid introducing security flaws. As an example, an indication of the version is also included in the hash value.

According to one embodiment, the header 200 further comprises the information 210 (RESOURCES INFORMATION). The information 210 comprises for example an indication of one or more resources of the electronic device 100 that will be used during execution of the application once it has been updated. As an example, the resources comprise peripheral circuits such as a interfaces (e.g., a UART interface), ports (e.g., a GPIO (General Purpose Input/Output) port), buses (e.g., I2C), or other types of peripheral circuits (e.g., cryptographic circuits, cameras, etc.) The resources further comprise for example software code for example stored in the non-volatile memory 106.

According to one embodiment, the information 210 further comprises an indication value. As an example, the indication value is an identification value of an application program concerned by the update. In another example, the indication value identifies a category, for example associated with one or more application programs. In another example, the indication value is comprised in the information 208.

According to one embodiment, the circuit 102 further comprises a table, or a list, of data, for example stored in the non-volatile memory 106. The table, or the list, of data comprises, in association with indication values, an indication of a set of resources authorized for this indication value. As an example, each application program is identified by an indication value, and the table, or list, of data comprises, in association with each application program, and therefore with each indication value, a set of values, each value identifying for example one or more resources of the device. In another example, the application programs are grouped in categories, each category being associated with an indication value. In this example, the table, or list, of data comprises for each category, and therefore in association with each indication value, a set of values, each value identifying for example one or more resources of the device. For each indication value, the associated set of resources represents resources of the device 100 for which access is authorized for the application programs identified, or categorized by the indication value.

According to one embodiment, on reception of a software update module, the circuit 102, in particular the processor 104, is configured to extract the indication value from the header 200. The circuit 102 is further configured to compare one or more resources indicated in the information 210 with the resources in the set of resources included in the table, or list, of data in association with the indication value.

As an example, the pieces of information 202, 204, 206, 208 and 210 of the header 200 are not encrypted. In another example, one or more of the pieces of information 202 to 210 is encrypted.

In the case where a software update module comprises a plurality of software sub-modules, the information 210 comprises for example an indication of the global resources, i.e., for the totality of the software module. The information 210 further comprises for example indications of resources for each software sub-module. The resources indicated, for each of the software sub-modules, belong to the set of global resources. Similarly, if a software sub-module comprises a level lower than other software sub-modules, the information 210 also comprises indications of resources for each of these other software modules of lower level. In addition, each resource indicated for each software sub-module of lower level then belongs to the set of resources indicated for the software sub-module.

FIG. 3 is a flow diagram illustrating the steps in an installation process of a software update module according to an embodiment of the present description. This process is implemented, for example, by the processor 104.

In a step 300, the electronic device 100 receives, for example through the interface 103, a software update module for an application program of the device 100. The software update module comprises a header whose structure is the structure of the header 200. The software update module further comprises a second part comprising, for example, a code for updating the application program concerned. As an example, the update code is encrypted. As an example, the software update module is then stored temporarily in a volatile memory of the circuit 102.

Following step 300, the process continues in a step 301 (OK?). As an example, the step 301 comprises a verification by the processor 104 of the authenticity and/or the integrity of the software update module. As an example, a verification of the authenticity of the software module is carried out on the basis of an authenticity value comprised in the information 204. As an example, a verification of the integrity of the software module is carried out on the basis of an integrity value comprised in the information 206. Methods for verifying the authenticity and/or integrity of software modules are known to those skilled in the art.

If the verification(s) carried out in step 301 fail (branch N), the process ends in a step 302 (INSTALLATION REJECTED). Step 302 comprises for example the deletion of the software update module from the volatile memory in which it was temporarily stored.

If the verification(s) carried out in step 301 are successful (branch Y at the output of block 301), the process continues in a step 303 (POLICIES COMPARISON OK?).

While step 303 is being carried out, the processor 104 extracts for example the indication value of the header and compares the resources indicated in the information 210 with the set of resources stored in the table, or list, of data in association with the indication value.

If at least one resource indicated by the information 210 is not comprised in the set of resources stored in the table, or list, of data in association with the indication value (branch N), the process ends with the completion of step 302. The application program is then not updated.

In the case where the software update module comprises a plurality of software sub-modules, step 303 is for example further carried out software sub-module by software sub-module.

If all the resources indicated by the information 210 are included in the set of resources stored in the table, or list, of data in association with the indication value (branch Y at the output of block 303), the process ends in a step 304 (INSTALLATION).

When the update code is encrypted, step 304 comprises the decryption by the cryptographic circuit 112 of the code. Step 304 further comprises the execution by the processor 104 of the update code leading to the updating of the application program.

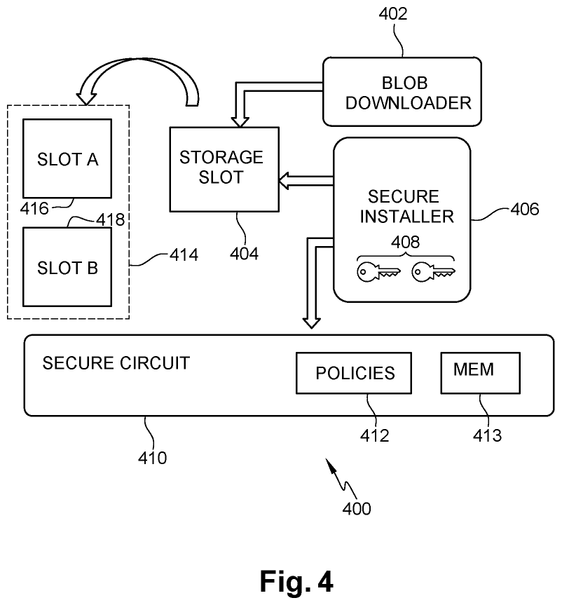

FIG. 4 is a block diagram illustrating the installation of a software update module according to an embodiment of the present description. In particular, FIG. 4 illustrates an example of a device 400 configured to implement the process described in relation to FIG. 3.

The device 400 comprises for example a download circuit 402 (BLOB DOWNLOADER) configured to receive software update modules. As an example, the download circuit 402 is similar to the interface 103.

The software update module is for example downloaded by the download circuit 402 from a server. The software module then comprises a header, for example the header structure 200 described in relation to FIG. 2. In particular, the header of the software module comprises an indication value associated with information such as indications of the resources of the device 400. As an example, the header further comprises indications of the application program concerned by the update together for example with an indication of the program version. The header further comprises for example an authenticity value and/or an integrity value of the module.

The device 400 further comprises a memory 404 (STORAGE SLOT) configured to temporarily store the software update module after being downloaded by the circuit 402.

The device 400 further comprises a secure installation circuit 406 (SECURE INSTALLER). As an example, the installation circuit 406 is a circuit similar to the processor 104. The installation circuit 406 is for example configured to carry out the verifications of authenticity and/or integrity described in relation to step 301, of the software update module stored in the memory 404. As an example, the verifications of authenticity and/or integrity are carried out on the basis of the authenticity and/or integrity values. As an example, the verifications of authenticity and/or integrity are further carried out on the basis of encryption keys 408, for example stored in an internal memory of the installation circuit 406.

The device 400 further comprises a secure circuit 410 (SECURE CIRCUIT) comprising a list, or table, of data 412 (POLICIES) as described in relation to FIGS. 2 and 3. The installation circuit 406 is further configured to carry out the step of comparison described in relation to step 303. In other words, the installation circuit 406 is further configured to extract the indication value from the header and to compare for example the resources indicated in the header with the resources indicated in the list or table 412, given in association with the indication value.

The list, or table, of data therefore comprises, for each application program of the device, or for each category of program, an indication of resources that may be used during the execution of the program. The programming of the list, or table, of data is for example carried out during the design of the circuit 102 and the devices 100 and 400. In other words, the contents of the list or table are decided before reception of the software update module. Those skilled in the art will therefore be able to choose, for each program, or each category of program, the resources of the device that it agrees to leave accessible by the program, or the category of programs.

As an example, the secure circuit 410 comprises a memory 413 (MEM) configured to store other elements such as OBK keys (Option Byte Keys).

The device 400 further comprises a non-volatile memory 414. As an example, the non-volatile memory 414 is similar to the memory 106. The non-volatile memory 414 comprises for example a memory location 416 (SLOT A) and a memory location 418 (SLOT B). When the comparison described in relation to step 303 is successful, the installation circuit 406 is configured to install the software update module in one of the locations 416 or 418. As an example, the location 418 is configured to store the application program concerned by the update and the software update module is then installed in the location 418. As an example, before the installation of the software update module, the installation circuit is configured to command the decryption, for example by a cryptographic circuit such as the circuit 112, of the encrypted part of the software module.

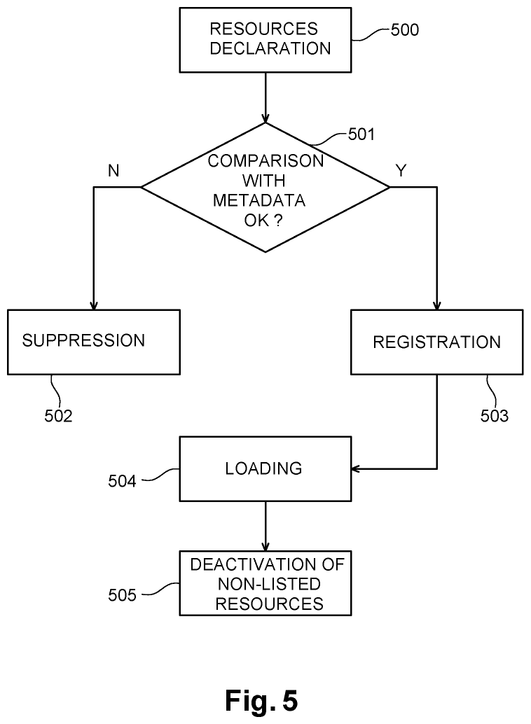

FIG. 5 is a flow diagram illustrating the steps in the recording process of a software update module according to an embodiment of the present description.

Once installed, i.e., following completion of step 304, a step 500 (RESOURCES DECLARATION) for example takes place. Step 500 comprises a declaration by the installed software module of one or more resources required for its execution. The declaration is for example carried out by the processor 104 under the control of the installed software module. As an example, the installed software module sends an indication of one or more resources required to the secure circuit 410.

In a step 501 (COMPARISON WITH METADATA OK?), the resources required are compared, for example by the secure circuit 410, with the resources indicated in the header of the software update module still stored in the memory 404. As an example, the software update module is kept in the memory 404 following its installation in a location of the memory 414.

When at least one among the declared resources required is not among the resources indicated in the header of the software update module (branch N), the process ends in a step 502 (SUPPRESSION). In step 502, the software update module together with its installation are deleted from memories 404 and 414.

When in step 501, if it is determined that all the resources required are among the resources indicated in the header (branch Y at the output of the block), the process continues in a step 503 (REGISTRATION). Step 503 includes for example recording the software module by the secure circuit 401. More specifically, the recording of the software module comprises for example the storage in a secure circuit 410 of an identifier of the application program associated with a set of resources, the set of resources being for example the resources required.

The completion of steps 500 to 503 then guarantees the exclusive use of the resources declared as being required.

As an example, when the software module comprises several software sub-modules, steps 500 to 503 are further carried out software sub-module by sub-module.

In a step 504 (LOADING) after step 503, the updated application program installed in location 416 or 418 is loaded, for example, into a volatile memory such as the memory 108 and is executed by a generic processor such as the processor 104.

The secure circuit 410 is then for example configured in a step 505 (DEACTIVATION OF NON-LISTED RESOURCES), to command the deactivation of all the resources not in the list of resources required for the application program loaded. Following the deactivation of the resources, the updated application program is for example executed by a generic processor such as the processor 104.

As an example, during execution of the updated program, each time an access to a resource is requested, the secure circuit 410 is configured to verify that the resource is among the required resources stored in association with the identifier of the program. If the resource is not among the set of required resources stored in association with the identifier of the program, then the secure circuit 410 is for example configured to forbid access to the resource.

In another example, an alternative to the embodiment described in relation to FIG. 5, when the updated program is executed, each time access to a resource is requested, the 410 secure circuit is configured to verify that the resource belongs to the set of resources stored in the data table. or the list of data, in combination with the indication value. For example, if the resource does not belong to this set, access to this resource is denied.

Registering the application is optional, but for example, the hint value associated with the application is kept in memory after the update so that any resource required for use when running the application can be verified to be a resource authorized by the data table, or the data list, in association with the hint value.

An advantage of the embodiments described in relation to FIG. 5 is that they provide double protection to the access of device resources. Indeed, they make it possible to verify, when a resource is required during the execution of an application, that this resource has been indicated, before the installation of the update, as being a resource authorized to be required by the application.

An advantage of the embodiments described is that they enable access to the resources of a device to be controlled for updates from the exterior.

Various embodiments and variants have been described. Those skilled in the art will understand that certain features of these embodiments can be combined and other variants will readily occur to those skilled in the art. In particular, the methods of encryption and decryption used can vary. Similarly, the implementation as a list or table of the indications 412 can vary.

Finally, the practical implementation of the embodiments and variants described herein is within the capabilities of those skilled in the art based on the functional description provided hereinabove, in particular concerning the implementation of the secure circuit 410.

1. A method, comprising:
receiving, by an electronic device, data comprising an application update module for an application program, the application update module comprising a first part, the first part comprising first update information and an indication value, the first update information indicating a set of resources used when executing an updated application program;
comparing, by a processor of the electronic device, the first update information with reference information associated with the indication value and stored in a memory of the electronic device, wherein the reference information associated with the indication value indicates a set of authorized resources for the indication value;
installing, by the processor, a second part of the application update module when the first update information corresponds to the reference information, thereby producing the updated application program; and
during the execution of the updated application program by the processor:
sending a request for use of a given resource of the electronic device; and
verifying, based on the indication value stored in association with the application program, whether the use of the given resource is authorized.

2. The method according to claim 1, wherein the indication value is an identifier of the application program.

3. The method according to claim 1, wherein the indication value is a value identifying a category of application programs.

4. The method according to claim 1, further comprising, before the comparison of the first update information with the reference information, verifying authenticity of the application update module.

5. The method according to claim 1, further comprising, before the comparison of the first update information with the reference information, verifying integrity of the application update module.

6. The method according to claim 1, wherein the first update information is non-encrypted data.

7. The method according to claim 1, wherein the second part of the application update module comprises encrypted data, the method further comprising, before installation of the second part of the application update module, decrypting said encrypted data using a cryptographic circuit of the electronic device.

8. The method according to claim 1, wherein the set of resources include peripheral circuits of the electronic device.

9. The method according to claim 1, wherein the set of resources include buses of the electronic device.

10. The method according to claim 1, wherein the set of resources include software codes stored in the memory of the electronic device.

11. The method according to claim 1, wherein the first update information corresponds to the reference information if the resources in the set of resources belong to the authorized set of resources.

12. The method according to claim 1, further comprising after the installation of the second part of the application update module, performing a recording phase in which the application update module is recorded, the recording phase comprising:
sending to the processor an indication of the set of resources to be used during execution of the updated application program;
comparing, by the processor, the set of resources to be used during execution of the updated application program with the set of resources indicated in the first update information; and
when the set of resources to be used during execution of the updated application program corresponds with the set of resources indicated in the first update information, storing the indication value in association with the application program.

13. The method according to claim 12, further comprising, if the first update information does not correspond to the reference information, deleting the application update module.

14. The method according to claim 12, further comprising, after installation of the application update module, and when the updated application program is active, deactivating resources not included in the authorized set of resources for the indication value.

15. The method according to claim 12, further comprising storing the authorized set of resources, in association with the indication value, in a memory of a secure circuit in the electronic device.

16. An electronic device, comprising:
an interface configured to receive data comprising an application update module for an application program stored in a memory, the application update module comprising a first part, the first part comprising first update information and an indication value, the first update information indicating a set of resources used when executing an updated application program; and
a processor configured to compare the first update information with reference information stored in the memory in association with the indication value, the reference information associated with the indication value indicating a set of authorized resources for the indication value, the processor further configured to command installation of the application update module if the first update information corresponds to the reference information to thereby produce an updated application program;
wherein the processor is further configured to, during execution of the updated application program, send a request for use of a given resource of the electronic device and verify whether the use of the given resource is authorized based on the indication value.

17. The electronic device according to claim 16, wherein the first update information corresponds to the reference information if the resources in the set of resources belong to the set of authorized resources.

18. The electronic device according to claim 16, wherein the processor is further configured to, after the installation of a second part of the application update module, perform a recording phase in which the application update module is recorded, the recording phase comprising:
sending to the processor an indication of the set of resources to be used during execution of the updated application program;
comparing, by the processor, the set of resources to be used during execution of the updated application program with the set of resources indicated in the first update information; and
when the set of resources to be used during execution of the updated application program corresponds with the set of resources indicated in the first update information, storing the indication value in association with the application program.

19. The electronic device according to claim 18, wherein the processor is further configured to, during the execution of the updated application program:
send a request for use of a given resource of the electronic device; and
verify, based on the indication value stored in association with the application program, whether the use of the given resource is authorized.

20. The electronic device according to claim 18, wherein the processor is configured to, if the first update information does not correspond to the reference information, delete the application update module.

21. The electronic device according to claim 16, wherein the processor is configured to, after installation of the application update module, and when the updated application program is active, deactivate resources not included in the set of authorized resources for the indication value.

22. The electronic device according to claim 16, wherein the processor is further configured to store the set of authorized resources, in association with the indication value, in a memory of a secure circuit.
